(19) United States
(12) Patent Application Publication
(10) Pub. No.: US 2023/0166864 A1
(43) Pub. Date: Jun. 1, 2023

(54) AGRICULTURAL AIRCRAFT TAILWHEEL JACK PAD

(71) Applicant: Dylan James Songer, Veedersburg, IN (US)

(72) Inventor: Dylan James Songer, Veedersburg, IN (US)

(21) Appl. No.: 17/931,680

(22) Filed: Sep. 13, 2022

Related U.S. Application Data
(60) Provisional application No. 63/283,565, filed on Nov. 29, 2021.

(51) Int. Cl. B64F 1/22; B66F 13/00

(52) U.S. Cl. CPC B64F 1/22; B66F 13/00

(57) ABSTRACT

An agricultural aircraft tailwheel jack pad adaptable to a distal end of a lifting ram of a jack. The agricultural aircraft tailwheel jack pad provides a main plate dimensioned and adapted to seat framing of the undercarriage of an aircraft adjacent its tailwheel. The agricultural aircraft tailwheel jack pad provides a connecting tube with weight-bearing gusset plates that support the main plate. The proximal end of the tube receives a distal end of the lifting ram that engages a contact plate withing the lumen of the tube.

### CROSS-REFERENCE TO RELATED APPLICATION

This application claims the benefit of priority of U.S. provisional application No. 63/283,565, filed 29-Nov.-2021, the contents of which are herein incorporated by reference.

### BACKGROUND OF THE INVENTION

The present invention relates to agricultural aircraft and, more particularly, an agricultural aircraft tailwheel jack pad.

Agricultural aircraft is aircraft that has been built or converted for agricultural use—usually aerial application of pesticides (crop dusting) or fertilizer (aerial topdressing); in these roles they are referred to as “crop dusters” or “top dressers”. The most common agricultural aircraft are fixed-wing aircraft, such as the Air Tractor™, Cessna Ag-wagon™, and other similar aircraft with “conventional landing gear”. Conventional landing gear is also known as tailwheel-type landing gear and includes an aircraft undercarriage having two main wheels forward of the center of gravity and a small wheel or skid to support the tail.

A common challenge with these types of agricultural aircrafts is having an easy way to jack up the agricultural aircraft's tailwheel at remote strips when they blow a tire. For instance, a typical solution would be a screw-action bottle jack (because hydraulic pressure is presumably not available). The bottle jack resembles a bottle by having a cylindrical body and a neck. Within is a vertical lifting ram that is movable between a retracted and extended position by turning a large nut running on the threaded vertical ram at the neck of the body. The nut may have gear teeth and is generally turned by a bevel gear on the body, the bevel gear being turned manually by a jack handle fitting into a square socket.

A bottle jack, however, has a lift range that somewhat limited and may not provide a vertical lift sufficient to remove the tailwheel of the aircraft and/or the distal end of the bottle jack is not inherently adaptable for the undercarriage of an agricultural aircraft, especially the tapering portion thereof and related aircraft framework that is adjacent to its tailwheel.

The problem with other solutions and products used to overcome this challenge in this field are their weight and movability. These other devices do not work well because they are very heavy and can only roll on smooth, hard surfaces.

As can be seen, there is a need for an agricultural aircraft tailwheel jack pad adapted so it can pick up the agricultural airplane for changing the aircraft's tire. The present invention is not a jack itself; rather the present invention is an adapter that engages a distal end of a bottle jack for providing a stable support pad dimensioned and adapted to lift the tail of the aircraft. As a result, the present invention improves on the other products because it is a very light product that also can be moved and used anywhere a bottle jack can be used.

### SUMMARY OF THE INVENTION

In one aspect of the present invention, a jack pad includes a seat plate extending longitudinally along a first plane, wherein the main plate longitudinally tapers; a tube extending from an underside of the seat plate; a plurality of gusset plates extending from an exterior surface of the tube so that each of the plurality of gusset plates support said underside; and a contact plate connected within a lumen of the tube inward of a proximal end thereof.

In another aspect of the present invention, the jack pad further includes wherein the plurality of gusset plates includes a pair of longitudinal gusset plates and a pair of latitudinal plates radially offset 180 degrees relative to each other, further including a pair of longitudinal sidewalls extending upward along opposing longitudinal edges of the seat plate, further comprising a handle extending from one of the pair of longitudinal sidewalls, and further comprising a plurality of holes formed through seat plate and the plurality of gusset plates.

In yet another aspect of the present invention, a method of adapting a lift jack to an undercarriage of an agricultural aircraft for elevating a tailwheel thereof off a supporting surface, the method including providing the above-mentioned jack pad sliding a distal end of a lifting ram of the lift jack into the proximal end of the tube until contacts the contact plate; seating a portion of a tail framing of the undercarriage along an upper surface of the seat plate; and operating the lift jack.

These and other features, aspects and advantages of the present invention will become better understood with reference to the following drawings, description and claims.

### BRIEF DESCRIPTION OF THE DRAWINGS

FIG. 1 is a top front perspective view of an exemplary embodiment of the present invention.

FIG. 2 is a bottom front perspective view of an exemplary embodiment of the present invention.

FIG. 3 is a front elevation view of an exemplary embodiment of the present invention.

FIG. 4 is a top plan view of an exemplary embodiment of the present invention.

FIG. 5 is a side elevation view of an exemplary embodiment of the present invention, shown in use.

FIG. 6 is an enlarged, detail section view of an exemplary embodiment of the present invention, taken along line 6-6 in FIG. 5.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an agricultural aircraft tailwheel jack pad adaptable to a distal end of a lifting ram of a jack. The agricultural aircraft tailwheel jack pad provides a main plate dimensioned and adapted to seat framing of the undercarriage of an aircraft adjacent its tailwheel. The agricultural aircraft tailwheel jack pad provides a connecting tube with weight-bearing gusset plates that support the main plate. The proximal end of the tube receives a distal end of the lifting ram that engages a contact plate withing the lumen of the tube.

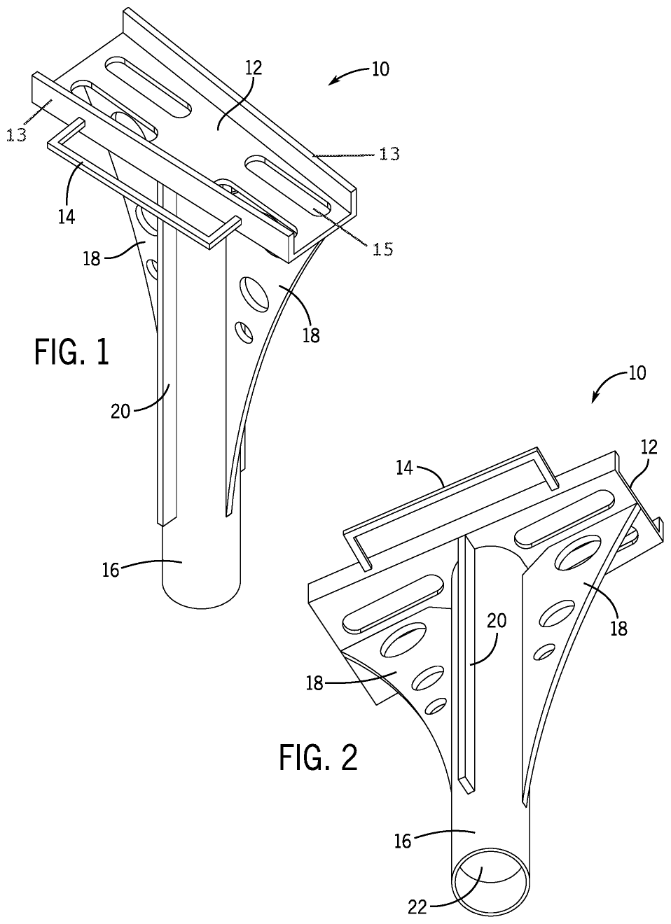

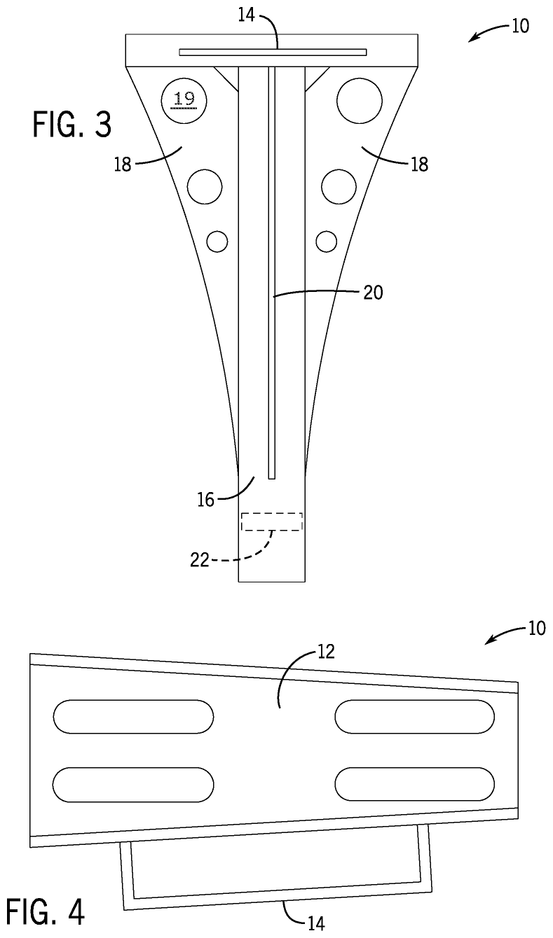

Referring now to FIGS. 1 through 6, the present invention may include an agricultural aircraft tailwheel jack pad 10. The tailwheel jack pad 10 may include main plate 12 that may be elongated and tapers as it extends along its longitudinal axis. The main plate 12 may provide a plurality of holes 15 that are also elongated in the direction of the longitudinal axis of the main plate 12.

Sidewalls 13 may extend generally perpendicularly and upward from each of the two opposing longitudinal edges of the main plate 12. A handle 14 may extend from one or both sidewalls 13.

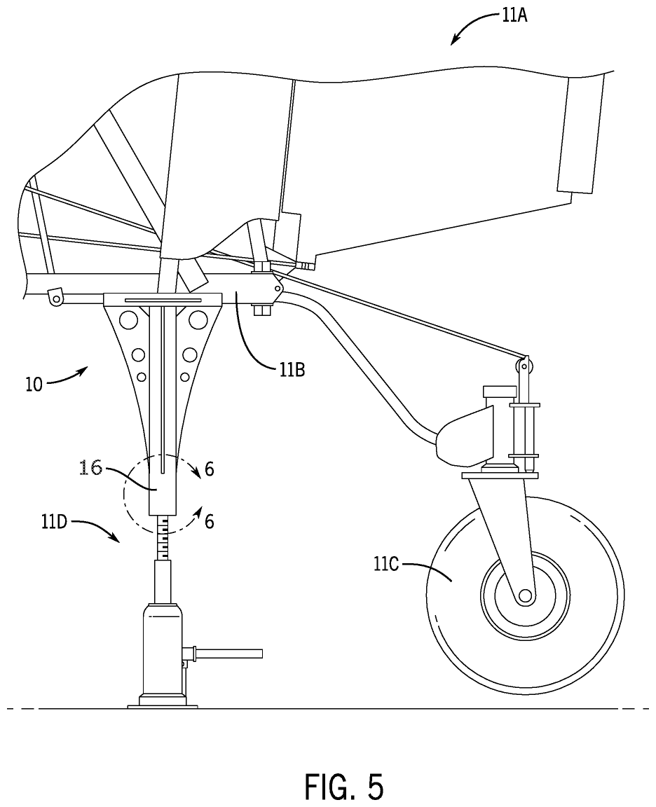

It should be understood that the main plate 12 may extend in a first plane, which is generally horizontal and parallel to a supporting surface of the tailwheel jack pad 10 during its use. Therefore, the sidewalls 13 extend vertically in an upward direction relative to the main plate 12. Upward and the other directional terms are best understood in view of FIG. 5.

Extending downward from an underside of the main plate 12, adjacent its center of inertia or thereabout, is a tube 16. Radially extending from an exterior of the tube 16 and connecting to the underside of the main plate 10 are a pair of longitudinal gusset plates 18 and a pair of latitudinal gusset plates 20. Each pair of gusset plates 18 and 20 may be two diametrically opposed gusset plates 18 or 20, with all four gusset plates 18 and 20 offset approximately ninety degrees relative to each adjacent gusset plate. The gusset plates 18 and 20 may have openings 19 formed therein.

A contact plate 22 may be disposed within the lumen of the tube 16, at an elevation that is below that of the lowest point of the gusset plates 18 and 20. The contact plate 22 is dimensioned and adapted to engage a distal end of the lifting ram of the bottle jack 11D, wherein said distal end first enters a proximal end of the tube 16 prior to contacting the contact plate 22, thereby increasing stability between the engagement as the distal end is restricted by the tube 16 from completely tilting away from the contact pad 22.

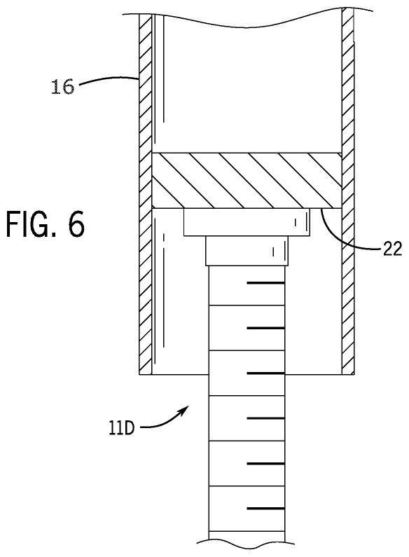

The above-mentioned components may all be welded together to create the tailwheel jack pad 10 that engages the top of a bottle jack 11D. The tailwheel jack pad 10 and the bottle jack 11D together pics up the tail 11A of the aircraft. The upside of the main plate 12 contact, engages, and seats a portion of the undercarriage and/or aircraft tail framing 11 B adjacent the tailwheel 11c. A user would use the present invention by placing it on top of a bottle jack 11D, as illustrated in FIGS. 5 and 6, herein the main plate 12 will cradle the tail spring 11B on the tail 11A of the aircraft so one can change the tailwheel tire 11C in remote places.

Additionally, the present invention could also be used in agriculture for picking up tillage tools or change parts.

A method of making the present invention would include the following. A manufacture may make he present invention by assembling the main plate 12, tube 16, primary gussets 18, and secondary gussets 20 cut out of steel or other sufficiently bending-resistant, strong, hard, and durable material. After the manufacturer forms or cuts, grind and/or mills these components, they can be cleaned tack welded to form one assemble disclosed herein.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A jack pad, comprising:
a seat plate extending longitudinally along a first plane, wherein the main plate longitudinally tapers;
a tube extending from an underside of the seat plate;
a plurality of gusset plates extending from an exterior surface of the tube so that each of the plurality of gusset plates support said underside; and
a contact plate connected within a lumen of the tube inward of a proximal end thereof.

2. The jack pad of claim 1, wherein the plurality of gusset plates includes a pair of longitudinal gusset plates and a pair of latitudinal plates radially offset 180 degrees relative to each other.

3. The jack pad of claim 2, further comprising a pair of longitudinal sidewalls extending upward along opposing longitudinal edges of the seat plate.

4. The jack pad of claim 3, further comprising a handle extending from one of the pair of longitudinal sidewalls.

5. The jack pad of claim 4, further comprising a plurality of holes formed through seat plate and the plurality of gusset plates.

6. A method of adapting a lift jack to an undercarriage of an agricultural aircraft for elevating a tailwheel thereof off a supporting surface, the method comprising:
providing the jack pad of claim 1;
sliding a distal end of a lifting ram of the lift jack into the proximal end of the tube until contacts the contact plate;
seating a portion of a tail framing of the undercarriage along an upper surface of the seat plate; and
operating the lift jack.
